(19) United States
(12) Patent Application Publication
(10) Pub. No.: US 2003/0093519 A1
(43) Pub. Date: May 15, 2003

(54) Supervisory control and data acquisition interface for tank or process monitor

(76) Inventors: Steven Jackson, Norcross, GA (US); Dirk Holcomb, Flowery Brunch, GA (US); Chris Abbott, Ivyridge (GB); Frank Van Bekkum, Norcross, GA (US)

Correspondence Address: Felix J. D'Ambrosio, P.O. Box 2266 Eads Station, Arlington, VA, 22202, US

(21) Appl. No.: 10/208,002

(22) Filed: Jul. 31, 2002

Related U.S. Application Data
(60) Provisional application No. 60/308,596, filed on Jul. 31, 2001.

(51) Int. Cl. G06F 15/173

(52) U.S. Cl. 709/224

(57) ABSTRACT

A tank side monitor includes two processor boards, a main/communication board, containing field communications interface circuitry and interface circuitry, and an optional IS module, containing HART interface circuitry. The two processor boards are link by an optically coupled serial communications bus. The HART circuitry is multiplexed and can be operated by either the Main/Communication board processor or a local processor on the HART IS board. The optional IS module, an extension of the HART IS board, provides options such as an IS 4-20 mA input or output or other IS I/O. The TSM employs a modular approach for hardware and software, whose implementation consists of a number of modules and programs, the first being the Main/Communications board software. Other programs are contained within the HART interface module. Due to the modular approach taken in the hardware design, the software is also modular and operates on two hardware modules: Main/Communications module software; and HART module software.

### CROSS REFERENCE TO RELATED APPLICATION

This application claims the benefit of the filing of Provisional Application No. 60/308,596, filed Jul. 31, 2001.

### BACKGROUND OF THE INVENTION

1. Field of the Invention

This invention relates to the field of interface devices for industrial process monitoring systems. More particularly, the invention pertains to remote maintenance and configuration of electronic data devices.

2. Description of the Prior Art

Modern compact personal computer-based supervisory control and data acquisition (SCADA) systems have their origin in dedicated process computers provided by control vendors. These computers were displaced by programmable logic controllers (PLCs), which replaced cumbersome relay logic for process control applications. More recently, the PC and PLC were combined to provide low-cost, compact, graphically based SCADA systems.

Such systems are used to remotely monitor and supervise or control diverse points in a process or a process component, such as a storage tank. These processes are characterized as having multiple, diverse geographic points that need to be supervised. Such systems relied on either dedicated hard-wired lines, analog telephone lines, fiber optic, microwave or UHF/VHF radios to communicate between a base station and remote locations. The input/output for these systems usually relied on remote terminal units as the remote portion of the control system.

Systems for controlling industrial processes employ transducers, gauges, flow meters and other devices for monitoring variables indicative of process and product conditions such as product level in a tank, average temperature, water level, HTMS pressure, vapor pressure, overfill, vapor spot temperature, and tank leakage. Such devices typically produce output 4-20 mA signals that are processed to produce information about the process.

The output signals from transmitters and process sensors are connected to a control system, such as a PC, or distributed control system so that processed data can be collected and analyzed, and the transmitters can be calibrated, adjusted and otherwise maintained. Control systems adapted to maintain the sensors and transmitters usually incorporate proprietary systems and protocols for the transmission of digital data received from and transmitted to the transmitters.

U.S. Pat. No. 5,432,711 describes an interface between a process instrumentation system whose process sensors and transmitters are located in a hazardous zone, and a control system adapted to maintain and configure the sensors and transmitters remotely through the interface. The interface includes a control section, a port replacement section, permanent electronic memory, temporary electronic memory, an address/data bus, UART, clock pulse generator, option selector, modem, channel selection decoder, wave shaping device, and multiplexer.

### SUMMARY OF THE INVENTION

The Tank Side Monitor (TSM) is primarily designed to provide electric power to, and interface with equipment for both new and existing tank monitoring systems. Although the TSM provides this primary function it will also supply a number of additional functions including collecting readings from sensing devices, performing tank calculations and supplying these readings and results to a control room.

A monitor according to the present invention includes two processor boards, a Main/Communication Processor Board, containing field communications interface circuitry and interface circuitry, and a HART IS Board, containing Intrinsically Safe (IS) HART interface circuitry. The two processor boards are linked by an optically coupled serial communications bus. The HART circuitry is multiplexed and can be operated by either the processor on the Main/Communication Processor Board or the local processor on the HART IS Board. An optional IS module, an extension of the HART IS board, provides options such as an IS 4-20 mA input or output or other IS I/O. The TSM employs a modular approach for hardware and software, whose implementation consists of a number of modules and programs, the first being the Main/Communications board software. Other programs are contained within the HART interface module. Due to the modular approach taken in the hardware design, the software is also modular and operates on two hardware modules: Main/Communications module software, and HART module software.

### BRIEF DESCRIPTION OF THE DRAWINGS

The figures listed below have been selected to illustrate a preferred embodiment of the present invention. FIG. 1 is a schematic diagram that shows a system comprising an interface between sensors or transmitters and a data acquisition and supervisory control unit.

FIG. 2 is an isometric view of an assembled tank side monitor according to this invention.

FIG. 3 is an isometric view of the main circuit pack assembly.

FIG. 4 is a block diagram of the electrical arrangement of the monitor.

FIG. 5 is a block diagram of the modular arrangement of the motherboard.

### DESCRIPTION OF THE PREFERRED EMBODIMENT

The following is a detailed description of the invention having particular reference to the drawings. The embodiments shown in the drawings are merely exemplary of the preferences of the inventors.

FIG. 1 shows a system for use with the interface device of this invention to monitor an industrial process, such as variables associated with a process storage tank (not shown). Analog and digital inputs 2 are connected to a PC 3 using a special purpose I/O card 4 or remote I/O stations 5 linked to the PC by various types of network communications 6. A graphical user interface 7 is provided so that various conditions readings and results of calculations based on the readings can be displayed, preferably at a control room or area remote both from the sensors and transmitters that produce the input signals and from the interface. The PC monitors the input signals representing condition variables, performs calculations using data derived from the input signals, executes control or supervisory logic, and performs supervisory functions that may include adjustment of the control variables.

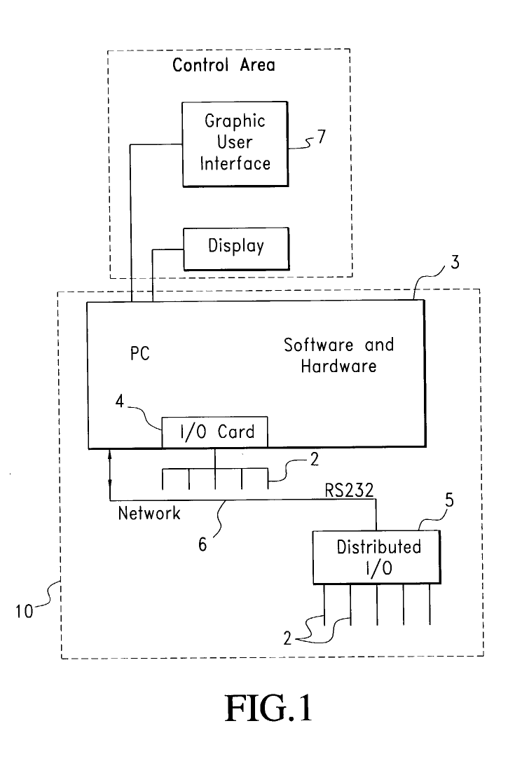

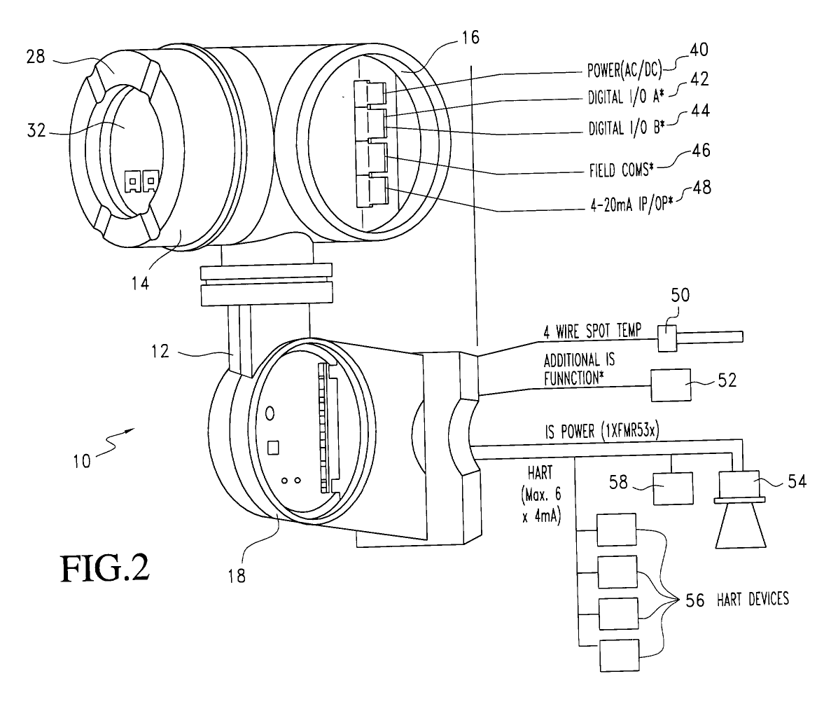

Referring now to FIG. 2, a tank side monitor (TSM) 10 according to this invention is enclosed in a flameproof container 12 divided into a main circuit compartment 14, Exd terminal compartment 16, and Exi terminal compartment 18.

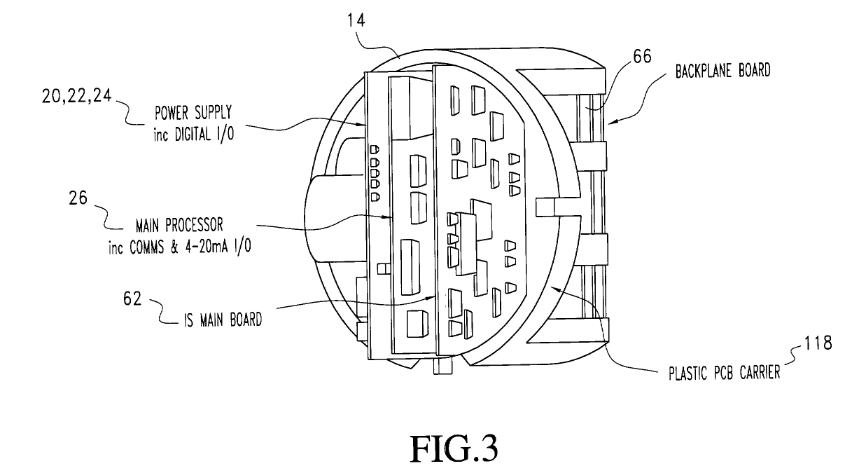

The main circuit compartment 14, shown in greater detail in FIG. 3, contains the main control circuits of the TSM such as the power supply 20, interface circuits 22, 24, control circuits 26 and user display 30. Due to the nature of these circuits, the main circuit compartment 14, including any divisions and paths leading from this compartment into any other compartments, is flameproof. Because the main circuit compartment also contains the user display 30, its cover 28 contains a window 32.

The Exd terminal compartment 16 is used to access electrical terminals for field communications, digital inputs and outputs, analog inputs and outputs other than instrumentation system (IS) terminals. Compartment 16 is accessed through a standard cover.

The Exi terminal compartment 18 is used to access IS terminals, and it too is accessed through a standard cover. Preferably cable entry to compartment 18 is made via a M24×1.5 Bartec cable feed through.

The general design and construction of the enclosure is of aluminum except for external fastenings, which are of stainless steel. All covers are sealed, and two external grounding points are provided. An optional bracket is available to simplify wall, pipe & rail installation. Referring now to FIGS. 2 and 3, the electrical and electronic components of the TSM are arranged in modular form, allowing the TSM to be adapted to various requirements using optional modules.

Exd terminals, carried on a non-IS terminal board 40 are housed in the Exd terminal compartment 16. The Exd terminals include the following electrical signals and functions: 48 VDC/240 VAC live and neutral power supply 42; protective ground; preferably at least two 48 VDC/240 VAC digital I/O terminal pairs 42, 44; and preferably at least eight 100 VDC field communication/4-20 mA IP/OP terminals 46, 48, each terminal being lightning protected. Terminal boards fixing screws having suitable shake proof washers provide a connection between the lighting protection and chassis ground.

Exi terminals, housed in the Exi terminal compartment 18, provide the following electrical signals and functions: four terminals for a 5 VDC four-wire IS spot temperature sensor 50; terminals for EExi optional 24 VDC functions 52 dependent on the module being used; two terminals for 24 VDC IS power supply 54; commoned terminal pairs for about six 24 VDC HART signals 56; and a terminal pair for 24 VDC HART signal commoned for HHT 58. The HART signals may be indicative of the variables such as the following: product level, average temperature, water level, HTMS pressure, vapor pressure, overfill, vapor spot temperature, and tank leakage.

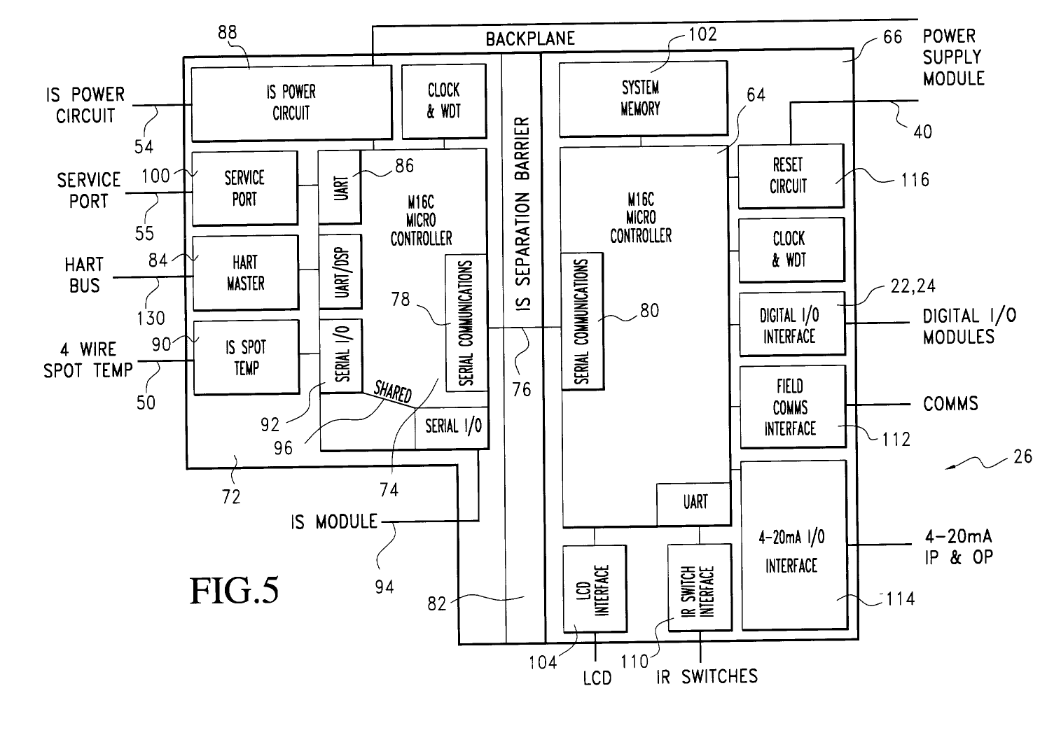

The motherboard module 60 component of the TSM 10 consists of a number of interconnecting circuit boards in a pack and arranged in compartment 14, as FIG. 3 shows. These boards, 20, 22, 24, 26 and IS main board 62 combined provide all the core system functionality and interfaces to the optional modules. Preferably the micro-controller 64 (FIG. 5) is a Mitsubishi M16C6N micro-controller, which accommodates a large number of peripheral devices, and has a large memory (10 Kb RAM, 256 Kb ROM), and a flash based architecture.

The circuit pack is assembled on a base plate or back plane board 66, which provides the main fixing point for the circuit boards into the enclosure case and provides a heat sink for components on the power supply boards.

There are two power supplies for the TSM due to the differing supply requirements, however both power supplies are located on a single circuit board and are connected to power supply modules 20 and digital I/O modules 22, 24. The power supply will consist of a switch mode device located within the flameproof compartment of the enclosure.

The digital I/O interface modules 22, 24, preferably Crydom SM series or the Greyhill Mini-series, provide various control and sensing options to the TSM 10 including the following required functions: DC input and AC input, DC output, and AC output, all of these having a 5V system interface.

The IS PCB 72, shown in detail in FIG. 5, in the circuit pack provides the TSM with various IS interface and functions including spot temperature 50, HART 56, IS service port 55 and additional IS modules 52. The IS PCB 72 contains its own M16C6N micro-controller 74, linked to the main system 64 using the serial communications interface 76 and serial communications controllers 78, 80. In order to maintain the IS separation requirements, approved opto-isolators will be used as well as a metal screen comprising an IS separation barrier 82 between board 72 and the main processor PCB 66.

The HART circuit 84 communicates with separate 4 mA HART devices 56, for example as many as eight, and complies with the requirements of the HART Foundation [“FSK Physical Layer Specification”, HCF_SPEC-54, Revision 8.0]. Its operating parameters include: VMAX=24V, IMAX=32 mA@VMIN=16V, and whose absolute maximum design values include: UMAX=30V, PMAX=1W, IMAX=100 mA. The HART circuit uses a HART modem IC, linked to a UART 86 on the micro-controller 74. The role of the UART is to provide for bi-directional communication between the workstation and transmitters. The UART converts the serial logic signals received by the interface from the workstation into parallel data, which can be processed by the micro-controller 74. The UART also receives parallel data from the micro-controller 74 and converts such data to serial data, which is communicated to the main workstation. The HART circuit allows a direct short circuit of the output terminals without causing any internal failures and without blowing any fuses.

The IS power circuit 88 provides the following output to an FMR53x radar gauge available commercially from Endress+Hauser having a place of business at ______ Its operating parameters are: VMAX=24V, IMAX=28 mA@VMIN=16V; and its absolute maximum design values are: UMAX=30V, PMAX=1W, IMAX=300 mA. Circuit 88 also allows a direct short circuit of the output terminals without causing any internal failures and without blowing any fuses.

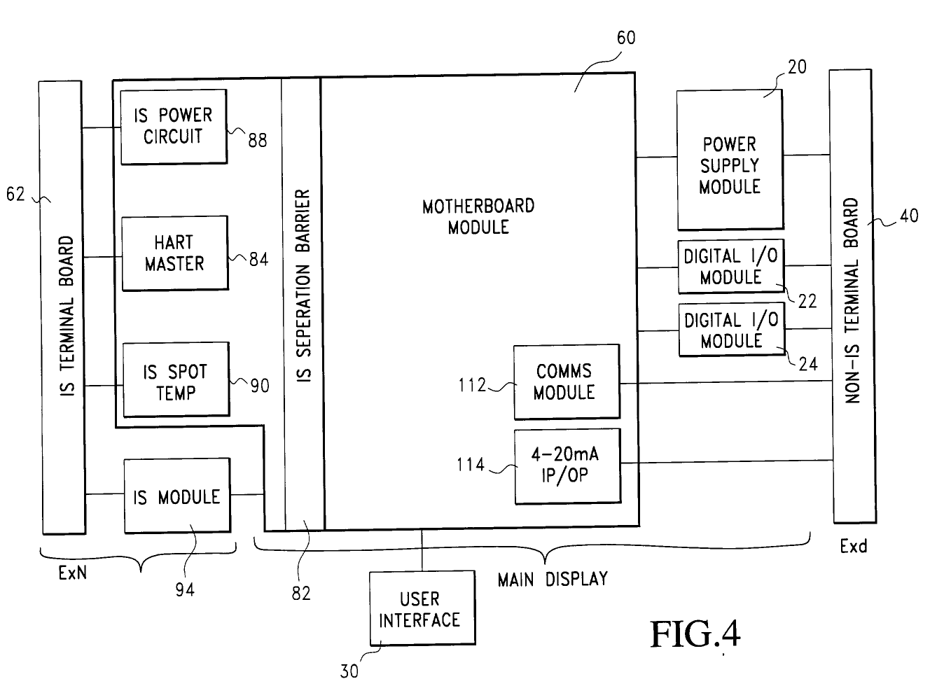

The spot temperature interface circuit 90 (FIG. 4) connects to a spot Pt100 temperature measurement device 50 (either three or four wire), and the circuit 90 interfaces directly with the micro-controller 74, using its clocked serial port 92 and some additional I/O pins. The IS module 94 is used to provide various optional functionality to the TSM and requires 420 mA input. It consists of a single circuit board that is plugged into the appropriate connector on the IS PCB 72. IS module 94 contains the appropriate interface circuit required to perform its function, and it is connected to a clocked serial bus 96 supplied by micro-controller 74 located on the IS PCB 72. Module 94 includes a serial memory device, which is used to provide the system with details of the module's functional, menu and other calibration details. This electrical interface to module 94 provides the following connections: to the Exi Terminal Compartment 18; Clocked Serial Communication Bus (including 2 general chip select signals); Pre-clamped Power Supplies (+5V@35 mA, +24V@25 mA, 7×Ground); and Board Identifier.

The service port 100, located in Exi terminal compartment 18, provides a limited +5V power supply and a 2-wire RS485 asynchronous communications channel interface. The purpose of port 100 is to direct diagnostic connection to a PC during in-house design and testing, extend site testing, provide a data logging module interface, and provide for upgrading software at the site. The circuit will connect directly to a UART 86 of the micro-controller 84, thereby allowing high-speed communication.

The main PCB 26 in the TSM pack, which contains the system micro-controller 64, is in overall control of the functions and facilities of the TSM. Board 26 contains additional memory 102 for the micro-controller, and a LCD interface 104 to a Flowtec 50098060 graphical display module 30, available from Endress+Hauser. Module 30 provides the display in the TSM; it consists of a 128×64 pixel LCD screen with a controllable backlight. A SED1565 LCD controller built into the unit via an 8-bit data bus and three additional control lines provides the interface. The main micro-controller 64 generates all the characters of the display in multiple fonts and sizes.

The communications module 112 on the main processor board 26 provides the primary interface between the TSM and the control room, using various communication protocols and 4-20 mA input and output functions 114. Module 112 is provided with its own isolated +24 VDC supply from the power supply and is optically isolated from the rest of the board. The various standard industry protocols available though the communication interface module 112 include: Wm550 Interface; Modbus Interface; Mark/Space Interface; Rackbus Interface; V1 Interface; Saab TRL12 Interface; Enraf GPU Interface; TIWAY Interface; and L&J Interface.

The TSM is lockable due to the function of a switch 116 located on the main PCB that will write-protect the TSM configuration parameters. Lead seals are provided on the main cover 12 in order to prevent this switch from being moved without authorization. The back plane board 66 provides means for connecting the main circuit boards 25, 26, 62 together. It is located at the rear of the plastic PCB holder 118, allowing direct connection of the power supply 20, 22, 24; main board 26; and IS board 62, along with an additional connector, which passes through the housing to connect to the non-IS terminal board 40.

Self-diagnostics fall into two main groups. The first group is the items that are required to meet various standards and system requirements, e.g. possible PTB requirements for self-testing of the spot-temperature ADC circuit. The second group consists of items that can be designed into the device to aid product development, system testing, installation and on-site problem solving, e.g. HART bus monitoring (voltage & current); IS power supply 54 (voltage & current); and internal fuse status. The purpose of the common software is to provide all the basic functionality required by both the main/communications module and the HART IS module. This functionality includes: a real time operating system; main/local database maintenance functions; internal calendar/time management functions; inter-processor communications protocol; a clocked serial bus; and serial communications device driver.

The real time operating system RTOS for the TSM is a proprietary RTOS, the RTXC system. A full specification and design documents for the RTXC system can be obtained from its supplier, ______.

The Main/Communications module and HART IS module both contain real time databases having both unique and common data items. Common functions are used to maintain, access and control access to the real time database used on both modules.

The Main/Communications and HART IS modules will both contain time and date management functions. These common functions are used for process scheduling and data time stamping.

The inter-processor communications protocol transfers configuration and acquired data within the TSM via the serial communications bus. The protocol allows for the following: transfer of measured & calculated values; transfer of configuration data; possible transfer of firmware upgrades; and both forward and backward compatibility between processor boards.

The clocked serial bus is used to connect to the following devices on the both circuit boards: Combined EEPROM, WDT, supply monitoring device; secondary EEPROM device; and a high accuracy A/D converter used for RTD temperature measurements. The M16C microcontroller has a clocked serial port, which is used to communicate with these devices. Functions of the RTXC will be used to provide highly efficient interrupt driven interface.

Within the TSM, communications between the Main/Communications module and the HART IS module are handled by a serial communications bus supporting the “TSM Inter-processor Communications Protocol.” The data rate of the serial communications bus is 38,400 baud. In order to support this functionality the driver software interfaces between the protocol layer and the hardware, handling the network addressing system, packeting of data and error handling.

The TSM is configured via a menu format on the TSM display; however, the data are maintained in an internal structure, which allows remote configuration over field communications and integration into other programs and modules. Both the Main/Communications modules and HART IS module within the TSM contain a unique data structure, which is applicable to the data items to be used and maintained by the respective module. Common data items are communicated between the modules using the provisions made in the “TSM Inter-processor Communications Protocol” when required. Any optional IS modules will be an extension of the HART IS module and will be contained in the HART data structures. The structure defined for this data allows: multi-lingual support; password level protection; and ability to map the data items for attached sensors to the internal data items used for calculations and transmitted to the host system.

The Main/Communications Module is the heart of the TSM; it contains on-board peripherals, user interface, and the communications interface circuitry. The elements of this software module include: common software; communications interface functions (hardware drivers and protocol hinders); graphical LCD display driver (includes multi-lingual support and character sets); user interface (menu system); a calculation engine for unit conversions, tank calculations, etc); global system configuration functions; and remote firmware upgrade process. Low-level hardware drivers control the process of receiving and transmitting data on the communications bus. Higher-level protocol handlers process data and configurations commands and transmit requested data items required by the different protocols.

The user interface of the TSM consists of a number of elements; display, keypad, and the menu system the user uses to navigate through the TSM configuration. The LCD display contains an Epson SED1565 compatible LCD controller chip that is memory mapped into the TSM system. The driver software required to run this display interfaces with the devices driver chip, which does not provide any functionality other than providing access to the display's internal memory and processing commands. Therefore, the LCD driver software contains all functions required including graphics functions, character generation (multi-lingual), inverse/flashing/underline functions as well as other basic functions, such as screen clearing.

The keypad consists of three IR buttons (−+E). The driver processes keypad signals in order to allow the user to navigate the menu system and set configuration parameters.

The TSM provides a menu system similar to that used on the Endress+Hauser FMR53x radar gauge. This menu structure allows the operator to configure and interrogate the TSM. All configuration data will be assembled and maintain in the Main/Communications module. The appropriate configuration data is then transmitted to and stored in the HART module, FMR53x and other supported devices.

The calculation engine component in the TSM software contains all functions that perform a mathematical action on measured values read from sensors. These functions include: units conversion; hydrostatic level & secondary level calculations; hybrid density calculations; hydrostatic tank deformation offset; tank shell temperature effects; and linear offset for gas propagation adjustment of a radar gauge. All these functions will reside in a separate source code file, such as a library, within the software for the Main/Communications module. Some of the functions provided by this calculation engine (e.g. units conversion) are software used by both modules.

System configuration consists of a few methods: first, a menu system that the user uses to locally configure parameters within the TSM; and second, one of the field communication lines. A third method of configuration involves using the Time of Flight (ToF) tool. The TSM is used as a gateway to provide a protected connectivity path for the ToF tool. The TSM contains a generic service port. This port provides an intrinsically safe barrier, so access to the port is via the Exi terminal compartment. The port uses RS485 protocol. By using a long cable (up to over 2000 feet) and an approved IS barrier device, the ToF tool can be used for FMR53x configuration with the HART interface. The software for the TSM receives data from the service port and transmits this data onto the HART bus. Data received on the HART bus is transmitted out the service port. The TSM provides a safe and efficient mechanism for configuring the radar gauge.

The HART IS module is the second main component of the system. It contains the HART and spot temperature interface, the service port, and controls for an additional IS optional module. The elements required in this software include: common software; HART bus driver, protocol & functional routines; spot temperature interface utilizing the clocked serial bus; IS module interface utilizing clocked serial bus); and system diagnostics and monitoring including a debug port.

The HART bus on the TSM consists of a two-wire communications system designed to connect with as many as six devices concurrently. Within the HART system, the TSM is the master; all devices connected to the bus are slaves.

The HART bus driver hardware 130 is placed on the IS region of the IS module circuit, which is interfaced to the micro-controller 74 using the following four wires representing signals: received data; transmitted data; carrier detect; and request-to-send. These signals are multiplexed and are routed to either the Main/Communications board or HART IS board micro-controllers UARTs 26, 86, thereby forming a multi-capable serial interface, running at 1200 baud, 1 start bit, 8 bit data, odd parity, 1 stop bit using hardware flow control.

The protocol for the HART bus is specified within the HART Foundation document “Data Link Layer Specification”, HCF_SPEC-81, Revision 7.1, which specification details the actual format of data send between devices on the HART bus 130.

This format is then used to send commands between the devices as specified in the HART foundation document [“Command Summary Information”, HCF_SPEC-99, Revision 7.1]. The actual commands are in three groups: Universal Commands [“Universal Command Specification”, HCF_SPEC-127, Revision 5.2]; Common Practice Commands [“Common Practice Command Specification,” HCF_SPEC-151, Revision 7.1]; and Device Specific Commands.” All of the Universal Commands are implemented, other command from the remaining two groups are implemented per requirements of the devices that will be attached to the system.

The operations of devices attached to the HART bus 130 are numerous. First, the HART bus must be polled to identify the devices attached to the bus. Once detected, the devices must be added into the system profile and checked against system configuration parameters. Once device detection is completed, the TSM regularly monitors the devices to obtain readings, adding them into the tank profile, and performing any calculation or operations that may be needed.

Along with the continuous monitoring of readings, the system also allows other command to be sent to these devices. These commands are configuration or dynamic value setting, commands passed directly through the TSM to the device, or debug commands. These will all be performed by the use of proper device management, allowing various software processes to share access to the HART bus device.

General access to these devices is through the HART universal commands [“Universal Command Specification”, HCF_SPEC-127, Revision 5.2]. Other functions are performed either using common practice commands or device specific commands as dictated by the devices documentation.

The transparent command pass through mode is not one that is required for any normal TSM operation; however, it is a vital diagnostic and configuration tool. This mode allows a system connected to either one of the field communication lines or connected to the service port to send commands directly to HART devices on the bus. This mode is selected through the TSM user interface. After selecting “transparent mode” and a data source field communication port or service port, data received at that port is transmitted onto the HART bus. Any data received on the HART bus will be transmitted to the data source port.

By using this system, any command may be sent to any device without the TSM having to specifically support it. It also solves timing issues that can occur due to the additional latency added by the field communications used. Normal polling and data collection are suspended during transparent mode. During this period, the TSM transmits the last acquired value for each parameter obtained through the HART interface and produces a report of HART offline status.

The tank side monitor consists of two processor boards, and an optional IS module. To reduce the number of circuit boards used to makeup the TSM, the main processor board also contains the field communications interface circuitry. Therefore, the main/communication boards have different interface circuitry depending on the type of host system to which the TSM will be interfaced.

The second processor board, the HART IS board, contains the HART interface circuitry. The two processor boards are link by a moderate speed, optically coupled serial communications bus. In addition, the HART circuitry is multiplexed and can be operated by either the Main/Communication board processor or the native processor on the HART IS board.

The optional IS module, an extension of the HART IS board, can provide options such as an IS 4-20 mA input or output or other IS I/O.

The TSM employs a modular approach for hardware and software, whose implementation actually consists of a number of modules and programs, the first being the Main/Communications board software. Other programs are contained within the HART interface module. Due to the modular approach taken in the hardware design, the software is also modular and operates on two hardware modules: Main/Communications module software; and HART module software. The individual requirements of the elements within the software are dictated by the hardware they control.

Although the form of the invention shown and described here constitutes the preferred embodiment of the invention, it is not intended to illustrate all possible forms of the invention. Words used here are words of description rather than of limitation. Various changes in the form of the invention may be made without departing from the spirit and scope of the invention as disclosed.

We claim:

1. A monitor for interfacing with sensors that produce electronic signals representative of conditions being monitored, comprising:
an enclosure carrying a first, a second and a third board;
said first board carrying connections to an electric power supply, and carrying interface circuits, control circuits and a graphic display interconnected by a serial communications bus;
said second board carrying first electrical terminals connected to digital input and digital output signals produced by the sensors, and analog input and analog output signals produced by the sensors; and
said third board connected to an IS power supply, connected by a serial communications bus to the first board, having components thereon interconnected by the serial communications bus, and carrying second electrical terminals connected to IS links including a spot temperature interface circuit and a HART circuit.

2. The monitor of claim 1 wherein said third board carries electronic serial memory, further comprising:
an IS module connected through said clocked serial communications bus of said third board, to a HART micro-controller and serial memory.

3. The monitor of claim 1 wherein said third board carries a UART producing bi-directional communications, further comprising:
an IS service port carried on said third board, providing a DC power supply and an asynchronous communication channel, connected by the serial communications bus to the UART and HART micro-controller.

4. The monitor of claim 1 wherein said first board further includes:
a system micro-controller and system electronic memory communicating with the system controller through the serial communications bus; and
a graphic display module for driving a LCD screen of the graphic display, said display module being provided with an LCD controller integral with said display module and communicating via a data bus, for displaying characters generated by the system micro-controller.

5. The monitor of claim 4 wherein:
said enclosure includes a plurality of compartments with that portion of said enclosure covering a first compartment including a window through which an LCD screen can be viewed from without the compartment; and
said first board further includes infrared switches whose states can be changed from outside said first compartment through said window without opening said first compartment.

6. The monitor of claim 5 wherein:
said enclosure includes three compartments each surrounding a respective one of said first, said second and said third boards.

7. The monitor of claim 1 further comprising:
a communications module carried on said first board, each communications module adapted for two-way communication in accord with various communication protocols, connected by the serial communications bus to the system micro-controller, and connected to the power supply, for producing two-way communication between said digital input and digital output signals produced by the sensors, and between analog input and analog output signals produced by the sensors.

8. The monitor of claim 7 wherein the communications module is optically isolated from other components carried on said first board.

9. The monitor of claim 4 further comprising:
a user interface carried on said first board, comprising the graphic display, a keypad, and a menu displayed on the LCD screen from which a user selects configurations parameters through use of the keypad;
a LCD controller chip that is memory mapped into system memory; and
graphic display driver software, interfacing with said controller chip, and adapted to generate characters on the LCD screen, to change graphics characters, and to clear the LCD screen.

10. A monitor for interfacing with sensors that produce electronic signals representative of conditions being monitored, comprising:
a system micro-controller controlled by a real time operating system and having a clocked serial port for communication with components of the monitor;
a clocked serial communications interconnecting components of the monitor;
system electronic memory communicating through the serial communications bus;
a user interface including a graphical LCD display and an IR keypad having IR buttons [, and a menu used to make user selection]; software providing the following functions:
a communications interface for controlling the process of receiving and transmitting data, commands and requests on the serial communications bus;
a LCD driver for generating characters on the display, changing said characters and clearing the display;
an IR keypad driver for processing signals produced by the keypad and allowing a user to configure and interrogate the monitor and to make selections from a menu stored in system memory; and
a calculation engine containing functions that mathematical operate on data values developed from signals produced by the sensors.

11. A monitor for interfacing with sensors that produce electronic signals representative of conditions being monitored, comprising:
a HART micro-controller controlled by a real time operating system and having a clocked serial port for communication with components of the monitor including a UART;
a HART bus interconnecting HART devices and the HART micro-controller;
a HART device and spot temperature interface; and
software providing a HART bus driver communicating through the HART bus to the HART micro-controller, said interface and UART, producing signals representing received data, transmitted data, carrier detect and request to send, said signals being multiplexed and routed to the HART micro-controller UART.

12. A system for determining and monitoring at least one process value, comprising:
sensors producing data signals representing a process value;
actuating devices for changing a process variable in response to control commands received by said actuating devices;
a data acquisition and control unit for receiving data as input representing a process value, for processing such input data, and for producing control commands in response to the processed input data, and operating with a inter-processor communications protocol; and
a communication system including a protocol conversion unit, the communication system adapted to receive signals produced by the sensors, to transmit data to and from said data acquisition and control unit, and to transmit control commands to the actuating devices using a communications protocol independently of said inter-processor communications protocol.

13. The system of claim 12, wherein the protocol conversion unit is an integral part of the data acquisition and control unit.

14. The system of claim 12, wherein said protocol conversion unit can be replaced as a module without changing the other portions of the system.

15. The system of claim 13, wherein said protocol conversion unit can be replaced as a module without changing the other portions of the system.

16. The system of claim 12, further comprising a container, and wherein said data acquisition and control unit is fastened on the exterior of said container.

17. The system of claim 16, wherein said data acquisition and control unit is fastened on the base of said container.

18. The system of claim 12, wherein at least two sensors are provided, and wherein said data acquisition and control unit uses the data measured by said at least two sensors for the purpose of checking one of: plausibility and correction.

19. The system of claim 12, wherein said data acquisition and control unit operates said actuating device when said sensor detects a critical value of the process value.

20. The system of claim 12, further comprising an operating and monitoring unit for configuring, parameterizing and diagnosing said sensor and/or actuating device.

21. The system of claim 20, wherein measuring values are graphically displayed at said operating and monitoring unit.

22. The system as defined in claim 21, wherein the measuring value is a fill level.

23. The system of claim 20, further comprising:
a remote control center; and
a virtual interface provided on the data acquisition and control unit, through which virtual interface data are communicated with a remote control center independently of an operating system used to control the system, and independently of an application program or operating program for controlling operation of the operating and monitoring unit.

24. A system for determining and/or monitoring at least one physical and/or chemical value, comprising:
at least one field device, sensor and/or actuating device constituting a system which make available data with respect to at least one physical and/or chemical process value and/or regulating/control data, wherein data communication within said system takes place by means of any arbitrary transmission protocol;
a separate central data acquisition/control unit in the field provided for use in an ex-zone to which the measured data and/or the regulating control data are made available; and
a protocol conversion unit to assure communication between said field devices and said separate control data acquisition/control unit, independently of the arbitrary transmission protocol used in said system.

25. The system as defined in claim 24, wherein said system includes an ex-zone, and an ex-D connection space and/or an intrinsically safe connection space is/are provided, which permits access to at least one data interface in said ex-zone, and wherein fire certification is not required.

26. The system as defined in claim 24, wherein at least two field devices and/or sensors are provided, and wherein said data acquisition/control unit uses the data measured by said at least two field devices and/or sensors for the purpose of checking one of: plausibility and correction.

27. The system as defied in claim 24, further comprising:
an actuating device, wherein said separate central data acquisition/control unit operates said actuating device when said at least one field device, or sensor, detects a critical value of the process value.

28. The system as defined in claim 24, further comprising:
an operating and monitoring unit for visualizing, configuring, parameterizing and diagnosing said at least one field device, sensor and/or actuating devices.

29. The system as defined in claim 28, wherein measuring values are graphically displayed at said operating and monitoring unit.

30. The system as defined in claim 29, wherein the measuring value is a fill level.

31. The system as defined in claim 30, wherein the measuring value is one of: an echo curve and a generating curve.

32. The system as defined in claim 24, wherein the process value determined and/or monitored is located in a hazardous zone.
